(19) United States
(12) Patent Application Publication
(10) Pub. No.: US 2026/0346487 A1
(43) Pub. Date: Nov. 5, 2026

(54) REMOVABLE ELECTRONIC CARRIER CAP FOR A PERSONAL CARE PRODUCT

(71) Applicant: The Gillette Company LLC, Boston, MA (US)

(72) Inventors: Alexander HILLER, Kronberg (DE); Christoph ZEGULA, Frankfurt (DE); Dominik JUELING, Hessen (DE); Jannik LOEPER, Hessen (DE); Janina ANDERSEN, Lower Saxony (DE); Lisa-Marie Hermine KRAUS, Frankfurt (DE); Boris HRICKO, Cifer (SK); Peter FILIPEK, Bratislava (SK)

(21) Appl. No.: 19/666,990

(22) Filed: May 4, 2026

Related U.S. Application Data
(60) Provisional application No. 63/799,961, filed on May 5, 2025.

(51) Int. Cl. B26B 21/40; A45D 27/29; B26B 21/52; H02J 7/70; H02J 50/10

(52) U.S. Cl. CPC B26B 21/405; A45D 27/29; B26B 21/526; H02J 7/731; H02J 50/10

(57) ABSTRACT

A removable electronic carrier cap for a personal care product with a cap having a first closed end and a second end defining an opening. The second end has one or more locking members. A housing is positioned within the cap. The housing has a first end and a second end. The first end of the housing defining an opening configured to receive a rechargeable power source. At least a first conductor rail and a second conductor rail are mounted to the housing. A charging interface is positioned at the first closed end of the cap. The charging interface has a first end portion and a second end portion. The first end portion of the charging interface is fixed to the first conductor rail, and the second end portion is fixed to the second conductor rail.

### FIELD

The present invention relates to electronic personal care products and more particularly to electronic personal care products having a removable cap to replace a power source.

### BACKGROUND

Personal care products (e.g., consumer appliances) are becoming more advanced and thus often require the incorporation of electronic components to deliver new and/or improved consumer benefits. Electronic components are subject to failure when exposed to a wet environment, such as the bathroom. Furthermore, electronic components must be small to fit within a personal care product, such as a razor or a toothbrush. Accordingly, electrical components and fittings are typically very delicate and can break easily. In order to provide a safe and functional personal care product, the electrical components must be assembled and sealed against water ingress in a reliable cost effective manner.

Typical powered handles have the electronic components in the body (e.g., top portion) of the device and a power source (e.g., battery) on the bottom side. To connect the battery, two electrical contacts are pulled from the handle printed circuit board assembly to the bottom and top ends of the battery to ensure the power supply of the printed circuit board assembly. Accordingly, the removable battery cap provides little if any functionality. New government regulations are starting to mandate that portable battery-powered devices must have user-replaceable rechargeable batteries, to reduce electronic waste.

Accordingly, there is a need to efficiently assemble and seal the electronic components of a personal care product in a simple and reliable manner to facilitate removal and replacement of the rechargeable power source.

### SUMMARY

The invention also features, in general, a simple, efficient removable electronic carrier cap for a personal care product with a cap having a first closed end and a second end defining an opening. The second end has one or more locking members. A housing is positioned within the cap. The housing has a first end and a second end. The first end of the housing defining an opening configured to receive a rechargeable power source. At least a first conductor rail and a second conductor rail are mounted to the housing. A charging interface is positioned at the first closed end of the cap. The charging interface has a first end portion and a second end portion. The first end portion of the charging interface is fixed to the first conductor rail and the second end portion is fixed to the second conductor rail.

The invention features, in general, a simple, efficient method of assembling a personal care product by providing a cap having a first closed end and a second end defining an opening. A first end of the housing is mounted to the first closed end of the cap. A first conductor rail and an opposing second conductor rail are secured to the housing. A charging interface is positioned at the first closed end of the cap. A first end portion of the charging interface is connected to the first conductor rail. A second end portion of the charging interface is connected to the second conductor rail. A rechargeable power source is positioned within the housing. The rechargeable power source contact on the first conductor rail is connected to a first terminal of the rechargeable power source. One or more locking members at the second end of the cap are removably engaged with one or more corresponding locking members on a personal care product handle. A second terminal of the rechargeable power source is connected to a corresponding power source contact on the personal care product handle. A first electrical contact of the first conductor rail is connected to a corresponding first electrical contact on the personal care product handle. A second electrical contact of the second conductor rail is connected to a corresponding second electrical contact on the personal care product handle.

The details of one or more embodiments of the invention are set forth in the accompanying drawings and the description below. It is understood that certain embodiments may combine elements or components of the invention, which are disclosed in general, but not expressly exemplified or claimed in combination, unless otherwise stated herein. Other features and advantages of the invention will be apparent from the description and drawings, and from the claims.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is a perspective view of an exemplary personal care product system in accordance with one nonlimiting embodiment of the present disclosure.

FIG. 2 is an assembly view of a personal care product of the personal care product system shown in FIG. 1.

FIG. 3 is an assembly view of a removable electronic carrier cap of the personal care product of FIG. 2.

FIG. 4A is a cross section view of the removable electronic carrier cap, taken generally along the line 4A-4A of FIG. 2.

FIG. 4B is a cross section view of the removable electronic carrier cap, taken generally along the line 4B-4B of FIG. 2.

FIG. 5 is a top perspective view of a housing of the removable electronic carrier cap of FIG. 3.

FIG. 6 is a top perspective view of a cap of the removable electronic carrier cap of FIG. 3.

FIG. 7 is a perspective view of the housing of the removable electronic carrier cap of FIG. 3.

FIG. 8A is a first perspective view of electronical components of the removable electronic carrier cap of FIG. 3.

FIG. 8B is a second perspective view of electronical components of the removable electronic carrier cap of FIG. 3.

FIG. 9 is a cross section view of the removable electronic carrier cap, taken generally along the line 9-9 of FIG. 2

FIG. 10 is a perspective view of a removable electronic carrier cap.

FIG. 11 is an assembly view of the removable electronic carrier cap of FIG. 10.

### DETAILED DESCRIPTION

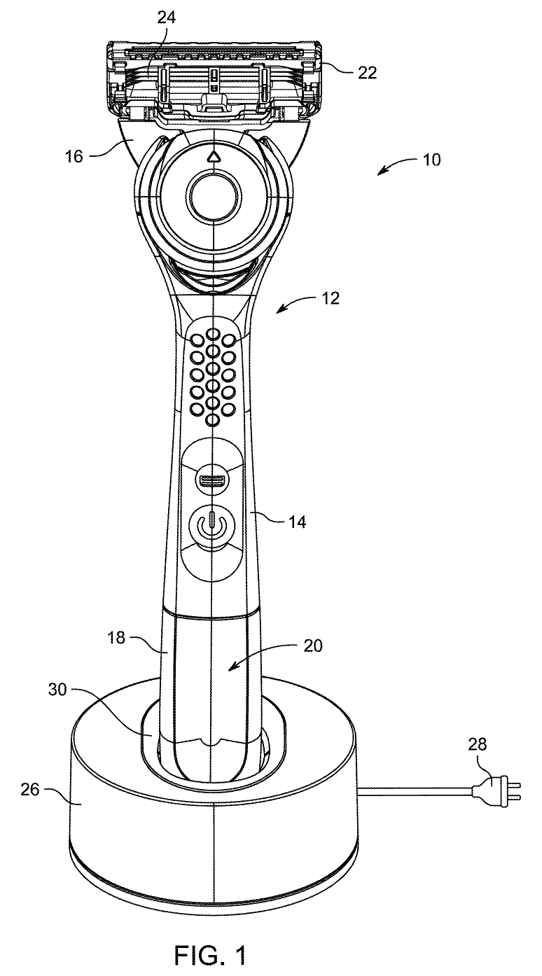

Referring now to FIG. 1, is a perspective view of an exemplary personal care product system 10 is depicted in accordance with one nonlimiting embodiment of the present disclosure. The personal care product system 10 may include a personal care product 12. It is understood that although the personal care product 12 is shown as a wet shaving razor, such depiction is for illustrative purposes only. Other examples of personal care products may include, without limitation, dry razors, epilators or other hair cutting and/or epilating household devices, trimmers, personal groomers, toothbrushes, light based hair removal devices, and so forth. The personal care product 12 may include a handle 14 having a first end 16 and a second end 18. The handle 14 may include one or more powered elements, such as LEDs, fluid pumps, motors, sensors, vibrating or oscillating components, heating elements, and so forth. A removable electronic carrier cap 20 may be removably mounted to the second end 18 to allow for removal of a power source (not shown) positioned within the handle 14.

It is understood that while a shaving razor cartridge 22 having one or more blades 24 is depicted as being coupled to the first end 16 of the handle 14, in other embodiments the handle 14 may additionally or alternatively include other types of personal care devices mounted to the handle 14, such as perforated shaving foils, rotary cutters, oscillating cutters, trimmers, and so forth. Accordingly, the handle 14 with the depicted shaving razor cartridge 22 coupled to the first end 16 is for illustrative purposes only and is not intended to limit the disclosure to any particular configuration of the handle 14, the personal care product system 10, or the personal care product 12. The shaving razor cartridge 22 (or other type of attachment or fixed implement) may be fixedly or pivotably mounted to the handle 14, depending on the overall desired cost and performance. The shaving razor cartridge 22 may be permanently attached or removably mounted to the handle 14. The shaving razor cartridge 22 may include the one or more blades 24, or other cutting instruments.

The personal care product system 10 may include the personal care product 12 and a stand 26 that is configured to receive at least a portion of the handle 12 of the personal care product 12. The stand 26 may include a power plug 28 that is configured to mate with an external power source, such as a wall outlet. While the power plug 28 is shown in FIG. 1 as being a conventional wall plug, in other configurations different power plug configurations can be used, such as USB chargers, for example. The handle 14 is shown in an docked position in relation to the stand 26 in FIG. 1. The stand 26 may define a recess 30 that is dimensioned to receive the second end 18 of the handle 14. In certain embodiments, an inductive charging system (not shown) positioned within stand 26 may charge the personal care product 12 when the handle 14 is docked to the stand 26 (e.g., the second end is placed within the recess 30). However, it is understood that the handle 14 may incorporate a non-rechargeable power source that does not require a charging system.

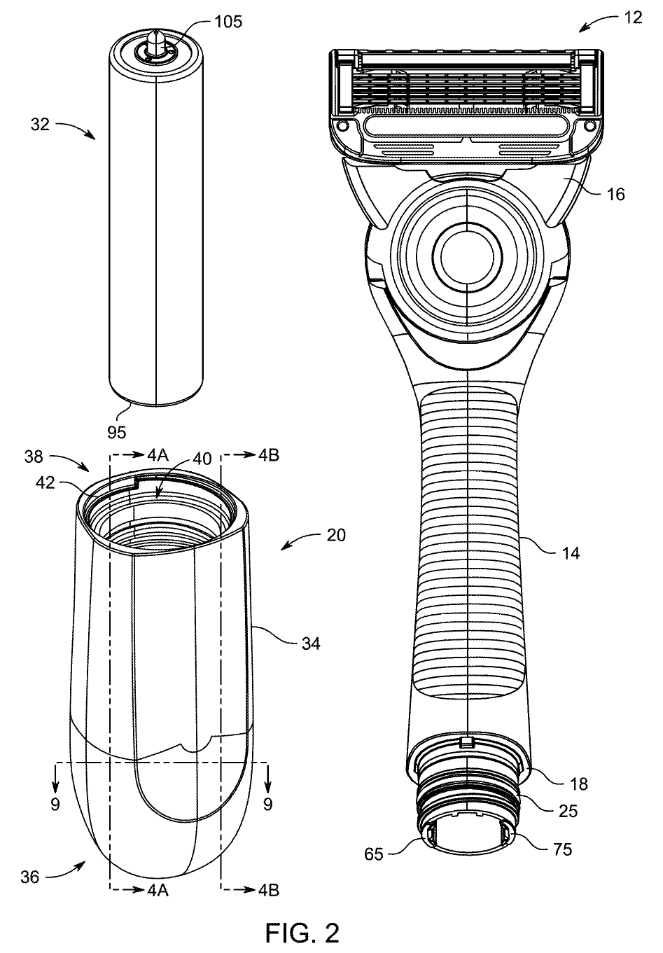

Referring to FIG. 2, a perspective view of the removable electronic carrier cap 20 is illustrated with a replaceable power source 32. The replaceable power source 32 may be a primary battery (i.e., single-use battery) or a rechargeable battery. For example, NiCd (Nickel-Cadmium), NiMH (Nickel-Metal Hydride) or Li-ion (Lithium Ion) rechargeable batteries may be used. The removable electronic carrier cap 20 may include a cap 34 having a first end 36 that is closed and a second end 38 that defines an opening 40. The opening 40 may be dimensioned to receive the replaceable power source 32. The second end 38 may have one or more locking members 42, such as threads, snap fits and/or bayonet members to temporarily mechanically secure the removable electronic carrier cap 20 to the handle 14 (FIG. 1). For example, the one or more locking members 42 may engage one or more corresponding locking members 25 positioned on the second end 18 of the handle 14. As will be described in greater detail below, the second end 18 of the handle 14 may have a pair of electrical contacts 65 and 75 to provide power functionality (such as LEDs or motors) to the handle 14 when connected to the removable electronic carrier cap 20.

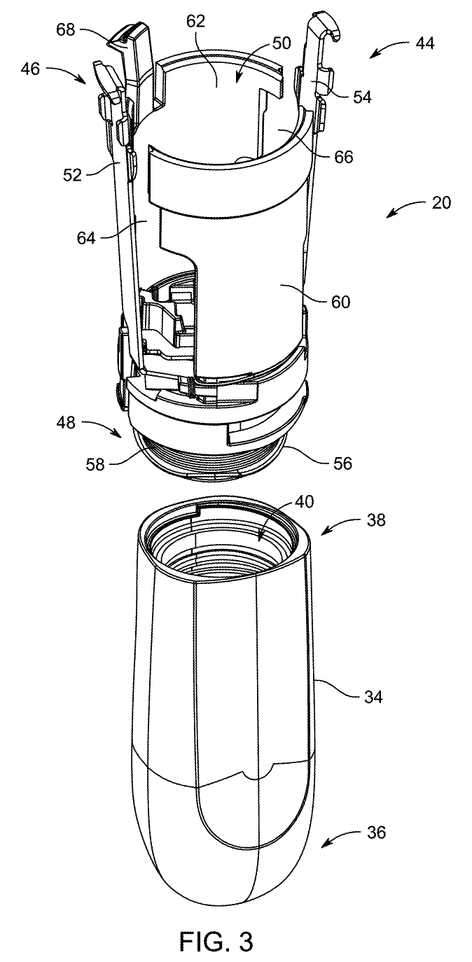

Referring to FIG. 3, an assembly view of the removable electronic carrier cap 20 of FIG. 2 is illustrated. The removable electronic carrier cap 20 may include the cap 34, as previously described, and a housing 44. The opening 40 defined by the cap 34 may be configured to receive the housing 44 (i.e., the housing 44 is at least partially positioned within the cap 34). The housing 44 may have a first end 46 and a second end 48. The first end 46 may define an opening 50 configured to receive the power source 32 of FIG. 2. As will be explained in greater detail below, the housing 44 may be fixed to the cap 34 so the cap 34 and the housing 44 do not become separated when the removable electronic carrier cap 20 is removed from the handle 14 to replace the power source 32.

At least a first conductor rail 52 and a second conductor rail 54 may be secured to the housing 44. The first conductor rail 52 and a second conductor rail 54 may be opposing. For example, if there are two conductor rails, they may be spaced approximately 180 degrees apart on the housing 44. If there are three conductors, then they may be spaced approximately 120 degrees apart on the housing 44. The first conductor rail 52 and a second conductor rail 54 may each be fixed to and in electrical communication with a charging interface 56 that is positioned at the second end 48 of the housing 44. Accordingly, the charging interface 56 may be located at the first end 36 of the cap 34 (e.g., toward a bottom of the opening 40). In certain embodiments, the charging interface 56 may include a charging coil 58 directly or indirectly assembled or mounted to the second end 48 of the housing 44.

The housing 44 may include two or more of spaced apart arms 60 and 62 that define two or more gaps 64 and 66. The gaps 64 and 66 may be dimensioned to receive one of the first conductor rail 52 and the second conductor rail 54 to provide improved flexibility during assembly of the housing 44 to the cap 34. For example, as the housing 44 is inserted into the opening 40 of the cap 34, the first conductor rail 52 and the second conductor rail 54 may flex inward (e.g., toward each other) and pass into and/or through the corresponding gaps 64 and 66. As shown in FIG. 3, the first conductor rail 52 may be positioned between the spaced apart arms 60 and 62 (within the gap 64) and the second conductor rail 54 may be positioned between the spaced apart arms 60 and 62 (within the gap 66). In addition, the spaced apart arms 60 and 62 may also provide flexibility to the housing 44 as the housing 44 is inserted into the opening 40. Furthermore, the conductor rails 52 and 54 may flex inwards to facilitate assembly.

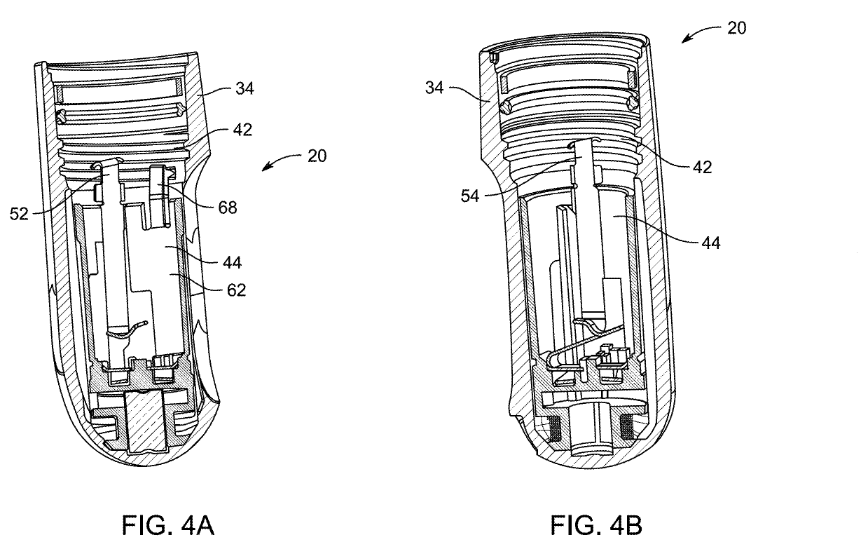

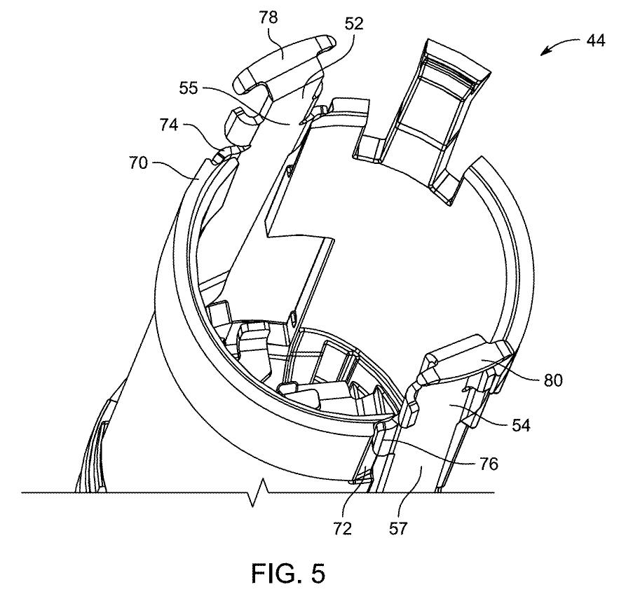

The first conductor rail 52 and a second conductor rail 54 may each engage an inner surface of the cap 34, as shown in FIGS. 4A and 4B. The housing 44 may include a locking tab 68 at the first end 46 of the housing (FIGS. 3 and 4A). The locking tab 68 may extend from one of the arms 60 and 62 to facilitate securing the housing 44 to the cap 34, as shown in FIG. 4A. For example, the locking tab 68 may flex outwardly against the cap 34 and engage one or more of the locking members 42 on the cap 34. The locking tab 68 may prevent the housing 44 from moving in an axial direction in relation to the cap 34, e.g., toward the opening of the opening 40. In certain embodiments, one or more of the spaced apart arms 60 and 62 may include one or more notches 70 and 72 dimensioned to receive at least a portion of one of the first conductor rail 52 and the second conductor rail 54 (FIG. 5). For example, the notch 70 of the arm 60 may engage a wing 74 of the first conductor rail 52. Similarly, the notch 72 of the arm 62 may engage a wing 76 of the second conductor rail 54. The notches 70 and 72 and the corresponding wings 74 and 76 may prevent the first conductor rail 52 and the second conductor rail 54 from flexing too far inwardly during assembly of the housing 44 to the cap 34, which may result in incorrect positioning of the first conductor rail 52 and the second conductor rail 54, causing a poor electrical connection.

Additionally, the notches 70 and 72 prevent distortion of the conductor rails in case the cap 34 is assembled to the handle 18 in a circular motion (e.g. screwed on the handle 18). The first conductor rail 52 may have an end forming an electrical contact 78. The electrical contact 78 may be generally flat and perpendicular to a longer extension 55 of the first conductor rail 52. Similarly, the second conductor rail 54 may have an end that includes an electrical contact 80. The electrical contact 80 may be generally flat and perpendicular to the to a longer extension 57 of the second conductor rail 52. For example, the ends 78 and 80 may be positioned between a pair of locking members 42, such as threads. The first conductor rail 52 and the second conductor rail 54 may flex inward when the conductor rails 52 and 54 are assembled in the power source cap 34 (FIG. 3). Accordingly, the electrical contacts 78 and 80 may then be properly in line and engage with the electrical contacts 65 and 75 of the handle 18 (FIG. 2) to provide a reliable electrical connection.

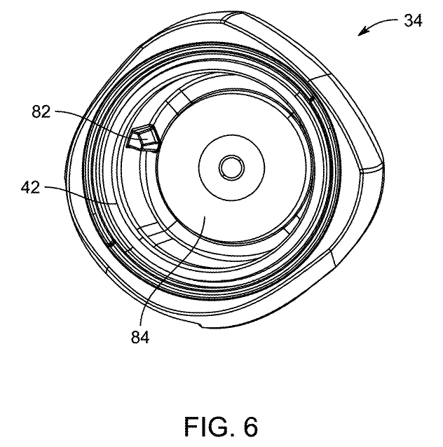

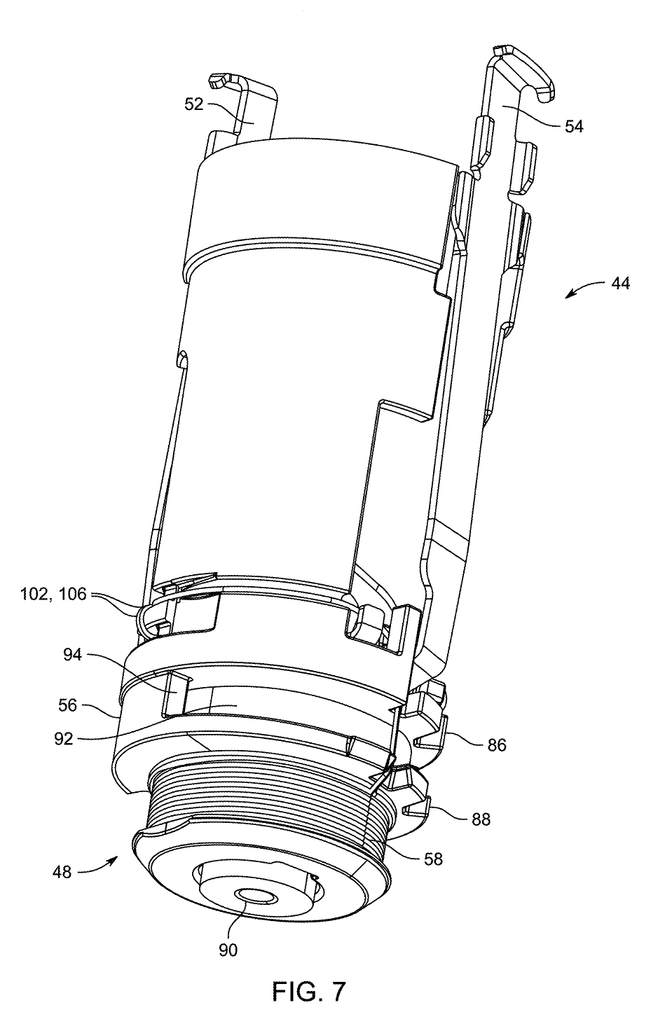

In certain embodiments, the cap 34 may include an axial rib 82 (FIG. 6) that is positioned between the locking members 42 and a bottom surface 84 of the cap 34. The axial rib 82 may help prevent the cap 34 from rotating relative to the housing 44 (FIG. 4A). For example, the axial rib 82 shown in FIG. 6 may engage one or more corresponding notches 86 and 88 on the housing 44 of FIG. 7. Accordingly, the combination of the axial rib 82 engaging the notches 86 and 88 along with the locking tab 68 engaging the locking member(s) 42 may secure the cap 34 to the housing 44 to prevent disassembly as the removable electronic carrier cap 20 is removed and attached from the handle 14 during replacement of the power source 32 (FIG. 1).

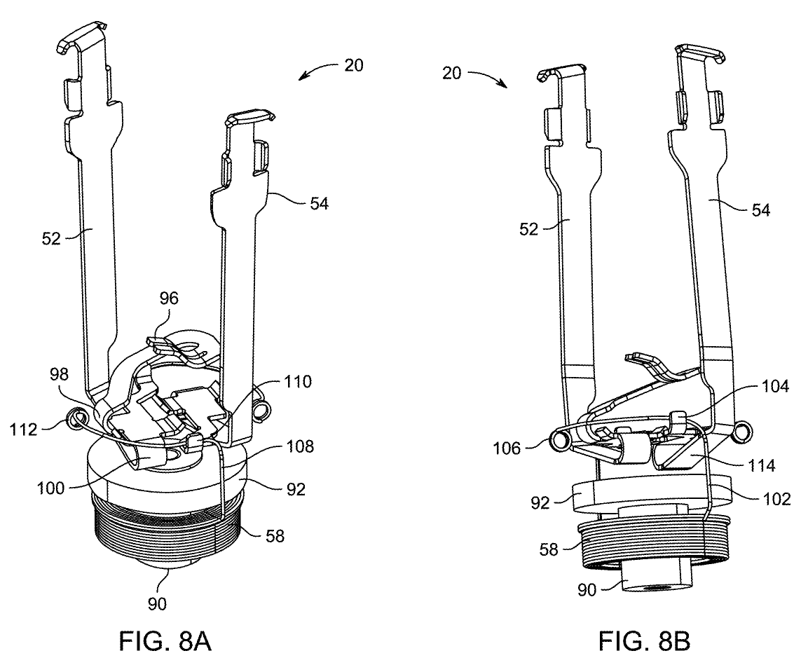

Referring to FIGS. 8A and 8B, perspective views of the removable electronic carrier cap 20 is illustrated with the housing 44 and the cap 34 removed for clarity of illustration. In certain embodiments, the charging interface 56 may include the charging coil 58, a ferrite rod 90 and/or a ferrite disc 92. The charging coil 58 may be directly or indirectly assembled or mounted to the second end 48 of the housing 44 and the ferrite rod 90 may be inserted into the second end 48 of the housing 44, as shown in FIG. 7. Accordingly, the charging coil 58 may be directly or indirectly assembled or mounted to the second end 48 of the housing 44 and/or the ferrite rod 90. However, it is understood that the charging coil 58 may be wrapped directly around the ferrite rod 90. The ferrite rod 90 may also be positioned within the ferrite disc 92, as shown in FIGS. 8A and 8B. In certain embodiments, the ferrite disc 92 and the ferrite rod 90 may be two separate components to facilitate assembly of the charging interface 56 to the housing 44. The ferrite disc 92 may be inserted into a slot 94 defined by the housing 44 (FIG. 7), then the ferrite rod 90 may be inserted into the second end 48 of the housing 44 and the ferrite disc 92. The ferrite disc 92 may be positioned between the charging coil 58 and at least one of the first conductor rail 52 and the opposing second conductor rail 54. The use and position of the ferrite rod 90 and the ferrite disc 92 may enhance magnetic coupling to increase charging efficiency. The ferrite rod 90 and/or the ferrite disc 92 may be optional depending on the desired level of charging efficiency.

The first conductor rail 52 may be formed from a single piece of material, i.e., integral, that is bent to form a power source contact 96. The power source contact 96 may provide an electrical connection with an electrical terminal 95 of the power source 32 , which may be positive or negative, of the power source 32 (FIG. 2). The power source 32 of FIG. 2 may also have a second electrical terminal 105 that engages a corresponding electrical terminal (not shown) in the handle 18. The first conductor rail 52 may be bent from a piece of metal (e.g., steel) to form a plurality of loops 98 and 100. The first loop 98 may extend in a generally perpendicular direction to the second loop 100 to properly position the power source contact 96. The one or more loops 98 and 100 may also provide axial flexibility to the first conductor rail 52. A first lead 102 may extend from the charging coil 58 and fixed to the first conductor rail 52, for example a solder joint 104. The first lead 102 may also have an end 106 that is secured to the housing 44 for additional security, as also seen in FIG. 7. The second conductor rail 54 may be formed from a single piece of material, i.e., integral. A second lead 108 may extend from the charging coil 58 (at an opposite end of charging coil 58 from the first lead 102) and fixed to the second conductor rail 54, for example, a solder joint 110. The second lead 108 may also have an end 112 that is secured to the housing 44 for additional security. The second conductor rail 54 may also have one or more loop portion 114 to provide axial flexibility to the second conductor rail 54.

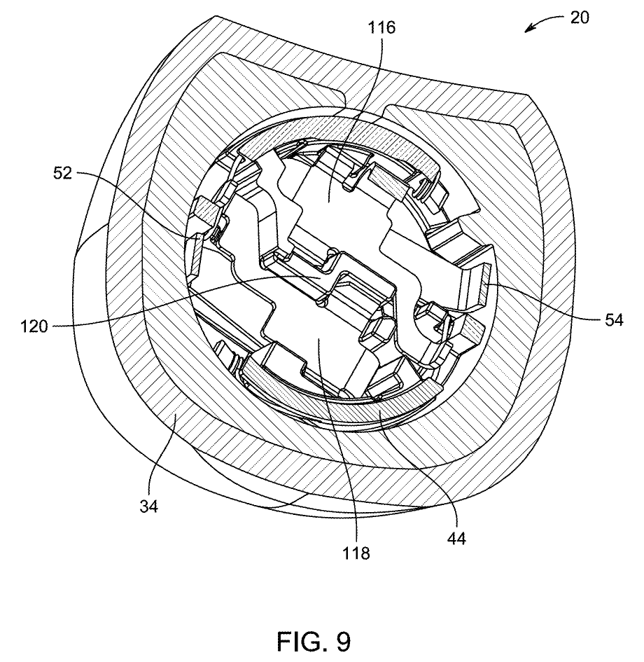

Referring to FIG. 9, a cross section view of the removable electronic carrier cap 20, taken generally along the line 9-9 of FIG. 2 is illustrated. A lower portion 116 of the first conductor rail 52 closest to the first closed end 36 (FIG. 3) of the cap 34 (FIG. 3) may be spaced apart from a lower portion 118 of the second conductor rail 54 closest to the first closed end 36 (FIG. 3) of the cap 34 (FIG. 3). The housing 44 may include a rib 120 positioned between the lower portion 116 of the first conductor rail 52 and the lower portion 118 of the second conductor rail 54. The housing 44 (e.g., the rib 120) may comprise a polymeric material to prevent electricity from conducting between the first conductor rail 52 and the second conductor rail 54.

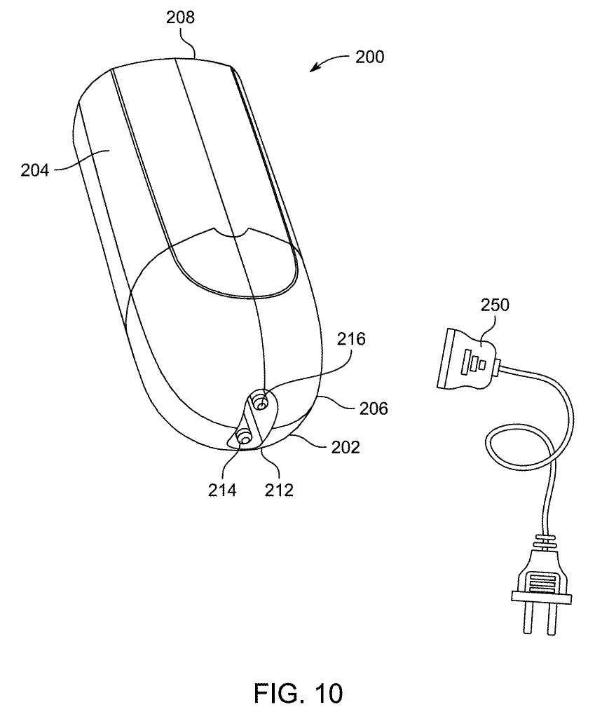

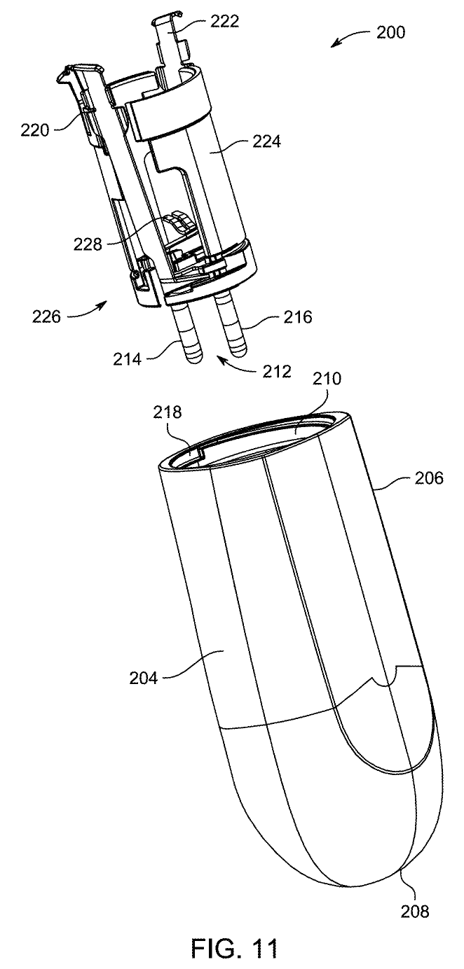

Referring to FIGS. 10 and 11, an alternative embodiment of a removable electronic carrier cap 200 is illustrated. The removable electronic carrier cap 200 may be substantially the same as the removable electronic carrier cap 20 described above. However, the removable electronic carrier cap 200 may include a charging interface 202 that does not require a charging coil. The removable electronic carrier cap 200 may include a cap 204 having a first end 206 and a second end 208. The second end 208 may define an opening 210 configured to receive the power source 32 (e.g., of FIG. 2). The first end 206 may include the charging interface 202 having a receptacle 212 dimensioned to receive a power plug (not shown). The receptacle 212 may include a first electrical contact 214 and a second electrical contact 216. The second end 208 may have one or more locking members 218, such as threads, snap fits and/or bayonet members to temporarily mechanically secure the removable electronic carrier cap 200 to the handle 14 (FIG. 1). For example, the one or more locking members 218 may engage the one or more corresponding locking members 25 positioned on the second end 18 of the handle 14 (FIG. 2).

At least a first conductor rail 220 and a second conductor rail 222 may be secured to a housing 224, similar to the first conductor rail 52 and the second conductor rail 54 described above in FIGS. 3-5. The first conductor rail 220 and a second conductor rail 220 may each be fixed to and in electrical communication with the charging interface 212 that is positioned at a second end 226 of the housing 224. Accordingly, the charging interface 212 may be located at the first end 206 of the cap 210 (e.g., toward a bottom of the opening 210). The charging interface 212 may include the first electrical contact 214 and the second electrical contact 216 that are configured to connect to a direct power source (e.g., wall outlet) via a plug (not shown). The first electrical contact 214 may be connected to the first conductor rail 220 and the second electrical contact 216 may be connected to the second conductor rail 222. The first conductor rail 220 may be bent to form a power source contact 228 that is configured to make electrical contact with the power source terminal 95 of FIG. 2.

### Representative Examples

A. A removable electronic carrier cap for a personal care product comprising a cap having a first closed end and a second end defining an opening, the second end having one or more locking members; a housing positioned within the cap, the housing having a first end and a second end, the first end of the housing defining an opening configured to receive a rechargeable power source; at least a first conductor rail and a second conductor rail mounted to the housing; a charging interface at the first closed end of the cap, the charging interface having a first end portion and a second end portion, wherein the first end portion of the charging interface is fixed to the first conductor rail and the second end portion is fixed to the second conductor rail.
B. The removable electronic carrier cap of paragraph A wherein the charging interface comprises a charging coil directly or indirectly mounted to the second end of the housing.
C. The removable electronic carrier cap of paragraph B further comprising a ferrite rod positioned within the charging coil.
D. The removable electronic carrier cap of paragraph C further comprising a ferrite disc positioned between the charging coil and at least one of the first conductor rail and the opposing second conductor rail, wherein the ferrite disc is separable from the ferrite rod.
E. The removable electronic carrier cap of any one of paragraphs A-D wherein the first conductor rail and the opposing second conductor rail each comprise a loop portion.
F. The removable electronic carrier cap of paragraph E wherein the first conductor rail and the opposing second conductor rail each flex in an axial direction towards and away from the first closed end of the cap.
G. The removable electronic carrier cap of any one of paragraphs A-F wherein the housing comprises a pair of spaced apart arms.
H. The removable electronic carrier cap of paragraph G wherein the first conductor rail and the opposing second conductor rail are positioned between the pair of spaced apart arms.
I. The removable electronic carrier cap of paragraph H wherein each of the pair of spaced apart arms includes a pair of notches dimensioned to receive at least a portion of the first conductor rail and the opposing second conductor rail.
J. The removable electronic carrier cap of any one of paragraphs A-I wherein the cap comprises an axial rib that engages at least one of the corresponding notches on the housing.
K. The removable electronic carrier cap of any one of paragraphs A-J wherein the first end of the housing comprises a locking tab that engages an inner surface of the cap.
L. The removable electronic carrier cap of any one of paragraphs A-K wherein the first conductor rail and the opposing second conductor rail each engage an inner surface of the cap.
M. The removable electronic carrier cap of any one of paragraph A-L wherein a lower portion of the first conductor rail closest to the first closed end of the cap is spaced apart from a lower portion of the second conductor rail closest to the first closed end of the cap.
N. The removable electronic carrier cap of paragraph M wherein the housing comprises a rib positioned between the lower portion of the first conductor rail and the lower portion of the second conductor rail.
O. The removable electronic carrier cap of any one of paragraphs A-N wherein the charging interface comprises a first electrical contact and a second electrical contact positioned within a receptacle dimensioned to receive a power plug.

The dimensions and/or values disclosed herein are not to be understood as being strictly limited to the exact numerical dimensions and/or values recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to anything disclosed or claimed herein or that it alone, or in any combination with any other reference or references, teaches, suggests or discloses anything disclosed or claimed herein. Further, to the extent that any meaning or definition of a term in this document conflicts with any meaning or definition of the same term in a document incorporated by reference, the meaning or definition assigned to that term in this document shall govern.

While particular forms of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A removable electronic carrier cap for a personal care product comprising:
a cap having a first closed end and a second end defining an opening, the second end having one or more locking members;
a housing positioned within the cap, the housing having a first end and a second end, the first end of the housing defining an opening configured to receive a rechargeable power source;
at least a first conductor rail and a second conductor rail mounted to the housing;
a charging interface at the first closed end of the cap, the charging interface having a first end portion and a second end portion, wherein the first end portion of the charging interface is fixed to the first conductor rail and the second end portion is fixed to the second conductor rail.

2. The removable electronic carrier cap of claim 1 wherein the charging interface comprises a charging coil directly or indirectly mounted to the second end of the housing.

3. The removable electronic carrier cap of claim 2 further comprising a ferrite rod positioned within the charging coil.

4. The removable electronic carrier cap of claim 3 further comprising a ferrite disc positioned between the charging coil and at least one of the first conductor rail and the opposing second conductor rail.

5. The removable electronic carrier cap of claim 1 wherein the first conductor rail and the opposing second conductor rail each comprise a loop portion.

6. The removable electronic carrier cap of claim 5 wherein the first conductor rail and the opposing second conductor rail each flex in an axial direction towards and away from the first closed end of the cap.

7. The removable electronic carrier cap of claim 1 wherein the housing comprises a pair of spaced apart arms.

8. The removable electronic carrier cap of claim 7 wherein the first conductor rail and the opposing second conductor rail are positioned between the pair of spaced apart arms.

9. The removable electronic carrier cap of claim 8 wherein each of the pair of spaced apart arms includes a pair of notches dimensioned to receive at least a portion of the first conductor rail and the opposing second conductor rail.

10. The removable electronic carrier cap of claim 1 wherein the cap comprises an axial rib that engages at least one corresponding notch on the housing.

11. The removable electronic carrier cap of claim 1 wherein the first end of the housing comprises a locking tab that engages an inner surface of the cap.

12. The removable electronic carrier cap of claim 1 wherein the first conductor rail and the opposing second conductor rail each engage an inner surface of the cap.

13. The removable electronic carrier cap of claim 1 wherein a lower portion of the conductor rail closest to the first closed end of the cap is spaced apart from a lower portion of the second conductor rail closest to the first closed end of the cap.

14. The removable electronic carrier cap of claim 13 wherein the housing comprises a rib positioned between the lower portion of the first conductor rail and the lower portion of the second conductor rail.

15. The removable electronic carrier cap of claim 1 wherein the charging interface comprises a first electrical contact and a second electrical contact positioned within a receptacle dimensioned to receive a power plug.

16. The removable electronic carrier cap of claim 1 wherein at least one of the first conductor rail and the second conductor rail are integral.

17. A method of assembling a personal care product comprising:
providing a cap having a first closed end and a second end defining an opening;
mounting a first end of the housing to the first closed end of the cap;
securing a first conductor rail and an opposing second conductor rail to the housing;
providing a charging interface at the first closed end of the cap;
connecting a first end portion of the charging interface to the first conductor rail;
connecting a second end portion of the charging interface the second conductor rail;
positioning a rechargeable power source within the housing;
connecting the rechargeable power source contact on the first conductor rail with a first terminal of the rechargeable power source;
removably engaging one or more locking members at the second end of the cap with one or more corresponding locking members on a personal care product handle;
connecting a second terminal of the rechargeable power source with a corresponding power source contact on the personal care product handle;
connecting a first electrical contact of the first conductor rail with a corresponding first electrical contact on the personal care product handle; and
connecting a second electrical contact of the second conductor rail with a corresponding second electrical contact on the personal care product handle.

18. The method of claim 17 further comprising a charging coil directly or indirectly mounted to the second end of the housing.

19. The method of claim 17 further comprising inserting a ferrite rod within an opening defined by the charging coil.

20. The method of claim 17 further comprising inserting a ferrite disc positioned between the charging coil and at least one of the first conductor rail and the opposing second conductor rail.
